(19) United States
(12) Patent Application Publication
(10) Pub. No.: US 2026/0145890 A1
(43) Pub. Date: May 28, 2026

(54) TRANSPORT APPARATUS, METHOD FOR CONTROLLING TRANSPORT APPARATUS, AND METHOD FOR MANUFACTURING PRODUCT

(71) Applicant: CANON KABUSHIKI KAISHA, Tokyo (JP)

(72) Inventor: TAKUMA HASHIZUME, Kanagawa (JP)

(21) Appl. No.: 19/389,666

(22) Filed: Nov. 14, 2025

(30) Foreign Application Priority Data
Nov. 22, 2024 (JP) 2024-203721

(51) Int. Cl. B65G 54/02

(52) U.S. Cl. CPC B65G 54/02

(57) ABSTRACT

A transport apparatus includes a stator including a curved section and a control unit that controls the position and the velocity of a mover that moves in a first direction while in contact with the stator. The control unit applies a driving force to the mover in a second direction that is perpendicular to the first direction when the mover moves on the curved section.

### BACKGROUND

### Field of the Technology

The present disclosure relates to a transport apparatus, a method for controlling a transport apparatus, and a method for manufacturing a product.

### Description of the Related Art

In general, at factory-automated manufacturing floors for assembling industrial products, transport systems are used to transport parts and other workpieces between a plurality of stations.

In recent years, transport systems have come into use that allow machining at a station while a workpiece is being held on a carriage, and after machining, transport the workpiece to the next process station while the workpiece is being held on the carriage. A moving magnet linear motor system (a moving magnet linear motor) has been developed as such a transport system.

A moving magnet linear motor system includes a mover having a plurality of permanent magnets mounted on a carriage to alternate N and S poles, a stator having a plurality of coils arranged in a travel direction of the carriage, and a current controller that supplies currents to the coils. In addition to the advantage in that machining can be performed while a workpiece is held on the carriage, the moving magnet linear motor system has an advantage in that it does not require wiring on the mover side, which eases restrictions on the transport path.

The transport system does not necessarily require that the stations be connected by a linear path, and they may be connected by a curved path. The return path may be configured so that a carriage that has completed a process can transport the next workpiece. As a connection between the forward and return paths, the system may be configured to have a curved section.

In a moving magnet linear motor system with linear and curved sections, the distance between the coil and the permanent magnet and the magnetic pole pitch vary between the linear and curved sections, which generally results in different control characteristics between the linear and curved sections and may cause vibration and oscillation.

Japanese Patent Laid-Open No. 2021-31232 describes a guiding mechanism that drives a mover in a curved section while controlling levitation of the mover with three coils facing a ferromagnetic rail based on the displacement of the mover in the width direction in response to the centrifugal force so that the amount of levitation of the mover is within a predetermined range. In addition, International Publication No. 2019/180908 describes a technology that determines the velocity of a mover based on the dimensions of an object to be transported and the radius of curvature of a curved section so that the mover travels in the curved section at a reduced velocity.

Providing a plurality of sensors on the transport path, as described in Japanese Patent Laid-Open No. 2021-31232, leads to an increase in apparatus cost. In addition, it is difficult to accurately detect minute displacements from the guide while considering the differences between the movers and between the sensors and the installation position variations of the mover and the sensors. In addition, traveling of the mover at a reduced velocity, as described in International Publication No. 2019/180908, has an impact on the takt time of the apparatus.

### SUMMARY

The present disclosure is directed to a technology regarding a moving magnet linear motor system that enables high-speed drive of a mover with reduced vibration that occurs in linear and curved sections without changing the transport velocity at a low apparatus cost.

According to an aspect of the present disclosure, there is provided a transport apparatus including a stator including a curved section and a control unit configured to control a position and a velocity of a mover that moves in a first direction while in contact with the stator, wherein the control unit applies a driving force to the mover in a second direction that is perpendicular to the first direction when the mover moves on the curved section.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic illustration of a moving magnet linear motor system according to a first embodiment.

FIG. 2 is a system configuration diagram according to the first embodiment.

FIG. 3A is a schematic illustration of a mover according to the first embodiment.

FIG. 3B is a schematic illustration of the mover according to the first embodiment.

FIG. 3C is a schematic illustration of the mover according to the first embodiment.

FIG. 4 is a schematic illustration of linear and curved sections of the moving magnet linear motor system according to the first embodiment.

FIG. 5 is a schematic illustration of linear and curved sections of the moving magnet linear motor system according to a second embodiment.

FIG. 6 is a schematic illustration of linear and curved sections of the moving magnet linear motor system according to a third embodiment.

FIG. 7A is a schematic illustration of control performed in a linear section of an existing system.

FIG. 7B is a schematic illustration of control performed in a linear section of the moving magnet linear motor system according to the first embodiment.

FIG. 8A is a schematic illustration of control performed in a curved section of an existing system.

FIG. 8B is a schematic illustration of control performed in a curved section of the existing system.

FIG. 8C is a schematic illustration of control performed in a curved section of the moving magnet linear motor system according to the first embodiment.

FIG. 8D is a schematic illustration of control performed in a curved section of the moving magnet linear motor system according to the first embodiment.

FIG. 9A is a schematic illustration of control performed at a boundary between a linear section and a curved section of an existing system.

FIG. 9B is a schematic illustration of control performed at a boundary between a linear section and a curved section of the existing system.

FIG. 9C is a schematic illustration of control performed at a boundary between a linear section and a curved section of the moving magnet linear motor system according to the first embodiment.

FIG. 9D is a schematic illustration of control performed at a boundary between a linear section and a curved section of the moving magnet linear motor system according to the first embodiment.

FIG. 9E is a schematic illustration of control performed at a boundary between a linear section and a curved section of the moving magnet linear motor system according to the first embodiment.

FIG. 9F is a schematic illustration of control performed at a boundary between a linear section and a curved section of the moving magnet linear motor system according to the first embodiment.

FIG. 10A is a schematic illustration of control performed in a curved section of an existing system.

FIG. 10B is a schematic illustration of control performed in a curved section of the existing system.

FIG. 10C is a schematic illustration of control performed in a curved section of the moving magnet linear motor system according to the second embodiment.

FIG. 10D is a schematic illustration of control performed in a curved section of the moving magnet linear motor system according to the second embodiment.

FIG. 11A is a schematic illustration of control performed at a boundary between a linear section and a curved section of an existing system.

FIG. 11B is a schematic illustration of control performed at a boundary between a linear section and a curved section of the existing system.

FIG. 11C is a schematic illustration of control performed at a boundary between a linear section and a curved section of the moving magnet linear motor system according to the second embodiment.

FIG. 11D is a schematic illustration of control performed at a boundary between a linear section and a curved section of the moving magnet linear motor system according to the second embodiment.

FIG. 11E is a schematic illustration of control performed at a boundary between a linear section and a curved section of the moving magnet linear motor system according to the second embodiment.

FIG. 11F is a schematic illustration of control performed at a boundary between a linear section and a curved section of the moving magnet linear motor system according to the second embodiment.

FIG. 12A is a schematic illustration of linear and curved sections of an existing system.

FIG. 12B is a schematic illustration of linear and curved sections of the moving magnet linear motor system according to a fourth embodiment.

FIG. 13 is a schematic illustration of control of driving forces in q-axis and d-axis directions according to the first embodiment.

### DESCRIPTION OF THE EMBODIMENTS

Embodiments of the present disclosure are described below with reference to the accompanying drawings. The embodiments described below are only examples, and the detailed configurations may be changed as appropriate by those skilled in the art without departing from the spirit of the present disclosure.

### First Embodiment

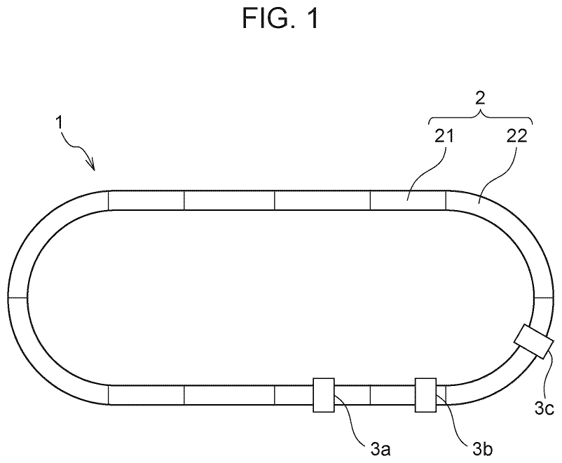

FIG. 1 is a schematic illustration of a moving magnet linear motor system according to the present embodiment.

The transport system 1, which is a moving magnet linear motor system according to the present embodiment, includes a stator 2 and a mover 3. The stator 2 includes a linear module 21 and a curved module 22. A plurality of movers 3 are arranged on the stator 2 and are driven along a guide (not illustrated). Although a simple circular ring configuration is illustrated in FIG. 1, the configuration is not limited thereto. The transport system 1 may be configured by a plurality of modules having different lengths and curvatures. In addition, although a configuration including three movers 3 is illustrated in FIG. 1, the configuration is not limited thereto. At least one mover 3 can be controlled on the stator 2.

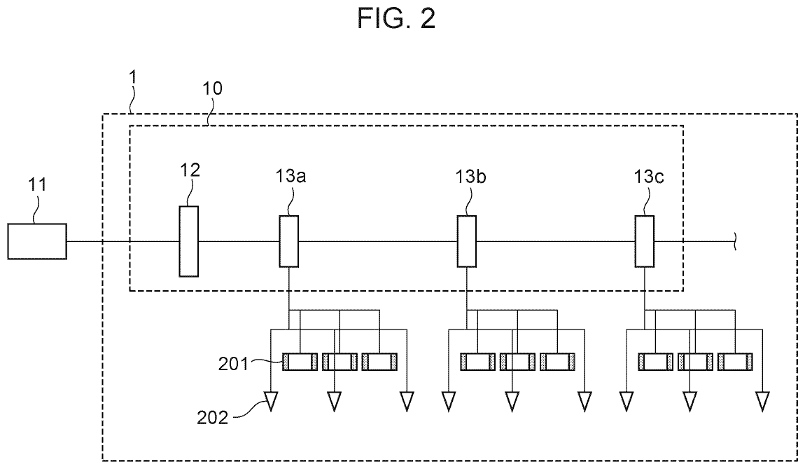

FIG. 2 illustrates the configuration of the transport system 1 according to the present embodiment. The transport system 1 includes a transport controller 12, such as a programmable logic controller (PLC), that is communicatively coupled to a higher-level system controller 11, and a plurality of motor controllers 13 that are communicatively coupled to the transport controller 12. Each of the motor controllers 13 is connected to a plurality of coils 201 arranged in the stator 2 and a plurality of sensors 202.

The plurality of coils 201 are arranged at predetermined intervals in a first direction, which is the transport direction. Each coil 201 may be a cored coil or a coreless coil. The plurality of coils 201 are divided into groups of, for example, three, and each of the groups is current-controlled. When energized, the plurality of coils 201 can generate an electromagnetic force with a permanent magnet 31 of the mover 3 and apply the force to the mover 3.

The plurality of sensors 202 illustrated in FIG. 2 are sensors that detect the position of the mover 3 in the transport direction. For example, each sensor 202 detects a linear scale 32 attached to the mover 3 and functions as a linear encoder that identifies the position of the mover 3 in the transport system 1.

In FIG. 2, a configuration is illustrated in which three coils 201 and three sensors 202 are connected to each of the motor controllers 13. However, the configuration is not limited thereto. At least one coil 201 and at least one sensor 202 are connected to each of the motor controllers 13 in accordance with the configuration of the modules 21 and 22.

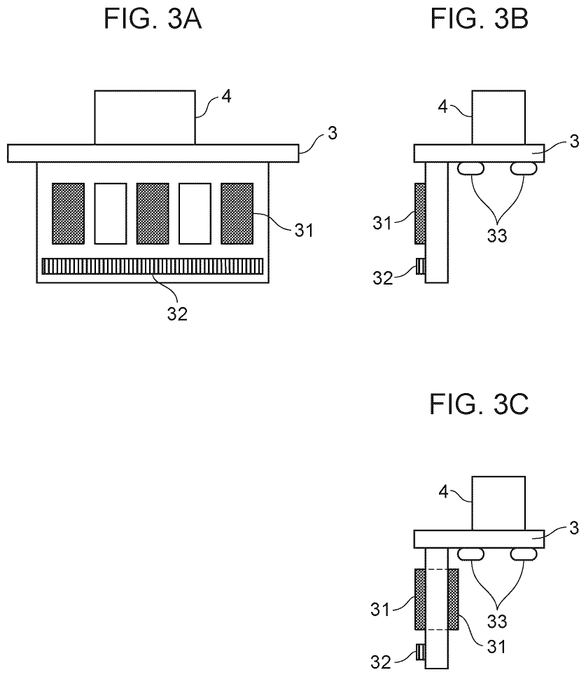

FIGS. 3A to 3C are schematic illustrations of the mover 3 according to the present embodiment. The mover 3 has a workpiece 4 loaded thereon and is transported on the stator 2. In the mover 3, a plurality of permanent magnets 31 are arranged in a first direction, each being able to face each of the coils 201, generate an electromagnetic force acting between the permanent magnet 31 and the coil 201 of the stator 2, and apply the force to mover 3. In FIGS. 3A to 3C, a configuration with five alternating N-pole and S-pole poles is illustrated. However, the configuration is not limited thereto.

The position of the mover 3 in the first direction is identified by the sensor 202 that detects the linear scale 32 fixed to the mover 3. As a sliding part 33 illustrated in FIGS. 3B and 3C, guide blocks or rollers are used, which move along a guide (not illustrated) fixed to the stator 2. By controlling an electric current applied to the coils 201, the mover 3 is driven and controlled while sliding on the guide.

A control unit of the moving magnet linear motor system serving as the transport system 1 is described below. As described above, the transport system 1 includes the transport controller 12 and the motor controllers 13, each motor controller 13 provided for each one of the modules. The transport controller 12 and the plurality of motor controllers 13 constitute the control unit 10 of the transport system 1. The positions of the plurality of movers 3 in the transport direction, which is the first direction of the transport system 1, are identified by the sensors 202 that are connected to the motor controllers 13 illustrated in FIG. 2.

The transport controller 12 identifies, among the plurality of motor controllers 13, the one that can control the mover 3 to be driven based on a transport command from the system controller 11. The motor controller 13 that can control the mover 3 is the motor controller 13 connected to the coil 201 that faces the mover 3.

The transport controller 12 notifies the identified motor controller 13 of drive profile information, such as a command position, velocity, and rate of acceleration or deceleration of the mover 3 to be driven.

The motor controller 13 derives driving force information to be applied to the mover 3 to be driven based on the received drive profile information.

The driving force information includes a driving force 40 that is a driving force in the transport direction, which is the first direction, and a driving force 41 in a d-axis direction that is a driving force in a second direction perpendicular to the first direction. In general, the driving force 40 in the transport direction is derived by a position controller, such as a proportional-integral-derivative (PID) controller, using the position information of the mover 3 in the transport direction. In addition, the driving force 41 in the d-axis direction is derived by a position controller, such as a PID controller, with a command value of 0. The driving force 41 in the d-axis direction is described in detail in the description of each of the embodiments below.

The motor controller 13 uses the driving force information to determine a current command value to be applied to each of the plurality of coils 201 connected to the motor controller 13 and perform current control. Thus, the motor controllers 13 can apply a desired driving force to the permanent magnet 31 of the mover 3.

Subsequently, to independently apply a force in the first direction and a force in the d-axis direction, which is the second direction perpendicular to the first direction, to the permanent magnet 31, the motor controller 13 determines current command values to be applied to the plurality of coils 201. Hereinafter, the first direction is also referred to as a “q-axis direction.”

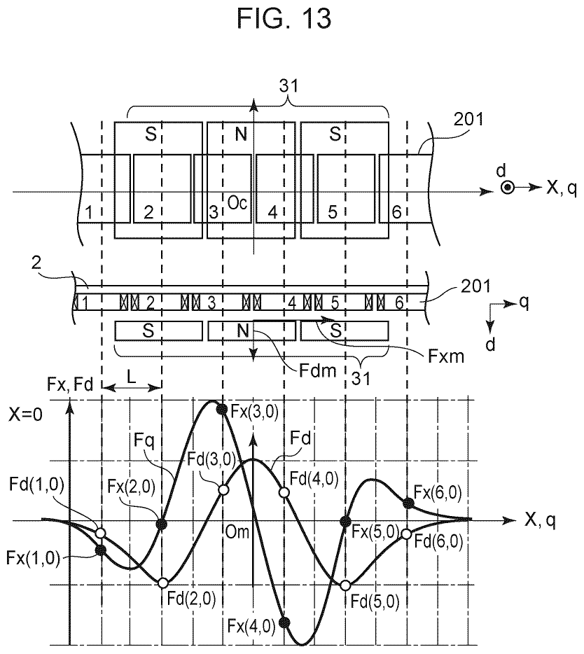

The q-axis and d-axis driving force control will now be described with reference to FIG. 13. The upper section of FIG. 13 is a view of six selected coils 201 that face the permanent magnets 31 as viewed from the d-axis direction (the second direction) when the X-axis (the first direction (q-axis direction)) extends horizontally. The middle section of FIG. 13 is a view of the upper section of FIG. 13 as viewed from a direction perpendicular to the first and second directions. To identify each of the coils 201, the coils 201 are assigned numbers j, from 1 through 6, based on the order in which they are aligned in the X-direction. In other words, each of the coils 201 is identified as “201(j)” (for example, a coil 201(1)).

As illustrated in the upper and middle sections of FIG. 13, the coils 201 are arranged at a pitch of L. However, the permanent magnets 31 of the mover 3 are arranged at a pitch of 3/2×L.

For simplicity, in FIG. 13, a center Oc position of the coils 201 in the X-direction is centered between the coils 201(3) and 201(4). In FIG. 13, the center Oc coincides with a center Om of the permanent magnets 31 in the X-direction. Thus, FIG. 13 illustrates the case of X=0 in which the center Oc and the center Om are the same.

The graph in the lower section of FIG. 13 is a schematic illustration of the magnitude of a force Fx in the X-direction and a force Fd in the d-axis direction generated when a unit current is applied to each of the coils 201 in the case of X=0 illustrated in the upper and middle sections of FIG. 13.

At this time, for example, the force acting on the coil 201(4) per unit current has a magnitude of Fx(4,0) in the X-direction and Fd(4,0) in the d-axis direction. The force acting on the coil 201(5) per unit current has a magnitude of Fx(5,0) in the X-direction and Fd(5,0) in the d-axis direction.

Let i(1) to i(6) denote the current values applied to the coils 201(1) to 201(6), respectively. Then, a magnitude Fxm of the force acting on the permanent magnet 31 in the X-direction and a magnitude Fdm of the force acting on the permanent magnet 31 in the d-axis direction are generally expressed as follows:

$$Fxm = Fx ( 1 , X ) \times i ( 1 ) + F x ( 2 , X ) \times i ( 2 ) + F x ( 3 , X ) \times i ( 3 ) + F x ( 4 , X ) \times i ( 4 ) + F x ( 5 , X ) \times i ( 5 ) + F x ( 6 , X ) \times i ( 6 ) , and \qquad ( 1 )$$

$$Fdm = Fd ( 1 , X ) \times i ( 1 ) + F d ( 2 , X ) \times i ( 2 ) Fd ( 3 , X ) \times i ( 3 ) + F d ( 4 , X ) \times i ( 4 ) + F d ( 5 , X ) \times i ( 5 ) + F d ( 6 , X ) \times i ( 6 ) . \qquad ( 2 )$$

By determining the current command values so that current values i(1) to i(6) that satisfy equations (1) and (2) are applied to the coils 201(1) to 201(6), respectively, forces can be applied to permanent magnets 31 independently in the X-direction and the d-axis direction. The motor controller 13 can determine the current command values to be applied to the coils 201j) in the above-described manner.

In the situation illustrated in FIG. 13, the case is discussed below where only the coils 201(3), 201(4), and 201(5) out of the coils 201(1) to 201(6) are used for the permanent magnets 31, and the sum of the current values of these three coils is controlled to be zero. In this case, the force Fxm acting on the permanent magnets 31 in the X-direction and the force Fdm acting on the permanent magnets 31 in the d-axis direction are expressed as follows:

$$Fxm = Fx ( 3 , X ) \times i ( 3 ) + F x ( 4 , X ) \times i ( 4 ) + F x ( 5 , X ) \times i ( 5 ) , and \qquad ( 3 )$$

$$Fdm = Fd ( 3 , X ) \times i ( 3 ) + F d ( 4 , X ) \times i ( 4 ) + F d ( 5 , X ) \times i ( 5 ) . \qquad ( 4 )$$

The current values of the coils 201(1) to 201(6) can be set to satisfy the following equations:

$$i ( 3 ) + i ( 4 ) + i ( 5 ) = 0 , and \qquad ( 5 )$$

$$i ( 1 ) = i ( 2 ) = i ( 6 ) = 0. \qquad ( 6 )$$

Therefore, in a case where the magnitude of a force (Fxm, Fdm) required for the permanent magnet 31 is determined, the current values i(1) to i(6) can be uniquely determined. By using the current command values determined in the above-described manner, a force is applied to the mover 3 in each of the X-direction and the d-axis direction. The force in the X-direction applied to the mover 3 serves as a driving force that moves the mover 3 in the X-direction. Thus, the mover 3 moves in the X-direction. According to the present embodiment, the force in the d-axis direction applied to the mover 3 controls the state of contact between the stator 2 and the sliding part 33 of the mover 3.

As described above, the transport controller 12 and the motor controllers 13 control the force applied to the mover 3 by controlling the currents applied to the plurality of coils 201.

In a case where the center Oc position of the coils 201 moves relative to the center Om of the permanent magnets 31 due to the driving of the mover 3 (that is, in a case of X≠0), the coil 201 that controls the current can be selected in accordance with the position to which the mover 3 moves. Furthermore, the same calculations as described above can be performed based on the force per unit current generated in each selected coil 201.

As described above, the transport system 1 controls the transport operation of the mover 3 on the stator 2 by determining the current command values of the currents applied to the plurality of coils 201 and performing control. Some functions of the motor controller 13 serving as part of the control unit 10 may be substituted by functions of the transport controller 12 or other control units.

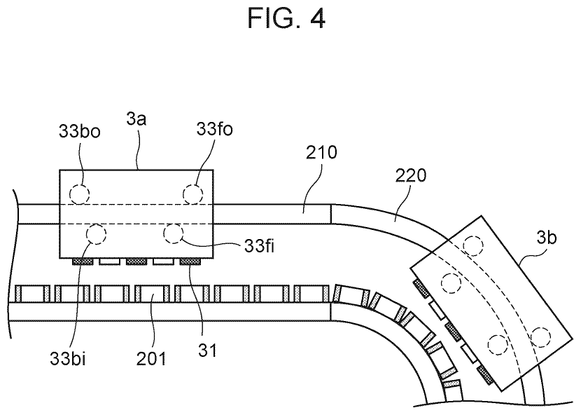

A driving method according to the first embodiment is described below with reference to FIG. 4 and FIGS. 7A to 9F. FIG. 4 illustrates the arrangement of the coils and permanent magnets according to the first embodiment. Movers 3a and 3b are disposed on a linear section guide 210 and a curved section guide 220, respectively, on the stator 2 (not illustrated), and the curved section has a so-called outer rotor configuration in which the coils 201 are disposed on an inner side in the radial direction. The mover 3 has, disposed therein, a front outside roller 33fo, a front inside roller 33fi, a rear outside roller 33bo, and a rear inside roller 33bi, which serve as the sliding part 33 on the guide.

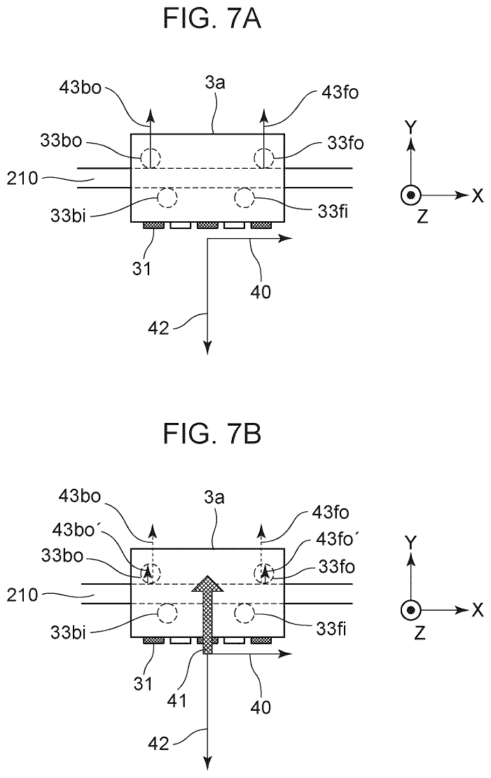

FIGS. 7A and 7B illustrate the mover 3a being driven on the linear module 21. In FIGS. 7A and 7B, the first direction, which is the transport direction, is the X-direction, and the second direction, which is perpendicular to the first direction, is the Y-direction. The Y-direction is the direction of a gap between the coil 201 (not illustrated) and the permanent magnet 31. Hereafter, the first direction is also referred to as the q-axis direction and the second direction as the d-axis direction.

FIG. 7A illustrates forces acting on a mover 3a of an existing system. The mover 3a is subjected to an attractive force 42 acting between the coil 201 (not illustrated) and the permanent magnet 31, a driving force 40 in the transport direction that acts in the first direction and that is controlled by the controller, and a contact force 43 acting between the linear section guide 210 and the sliding part 33. Therefore, since control is performed with the driving force in the d-axis direction being 0, the attractive force 42 and the contact force 43 are balanced and, thus, the mover 3a is controlled to be transported in the first direction while guided by the guide.

FIG. 7B illustrates forces acting on the mover 3a according to the first embodiment. In addition to the forces illustrated in FIG. 7A, a driving force 41 in the d-axis direction (the second direction) is applied to the mover 3a. The driving force 41 in the d-axis direction can act on the mover 3a to reduce the contact force 43 by being applied as a driving force in the direction opposite to the attractive force 42. In FIG. 7B, contact forces 43bo and 43fo (denoted by dashed lines) are reduced to contact forces 43bo′ and 43fo′ (denoted by solid lines) by the driving force 41 in the d-axis direction.

A method for determining the driving force 41 in the d-axis direction on the linear module 21 is described below.

As described above, the attractive force 42 and the contact force 43 act on the mover 3a as the forces in the second direction. The magnitude of the attractive force 42 is determined in accordance with the gap between the coil 201 and the permanent magnet 31. Therefore, by holding attractive force information in, for example, the transport controller 12 or the motor controller 13 and using a magnitude Fmag of the attractive force 42, which is the attractive force information, a magnitude FdRef of the driving force 41 in the d-axis direction can be determined as follows:

$$FdRef = - Gain \times Fmag , \qquad ( 7 )$$

where Gain is the effective ratio of the driving force 41 in the d-axis direction to the attractive force 42. For example, in a case where Gain=1, a force equal in magnitude to the attractive force 42 and directed oppositely is applied to the mover 3a as the driving force 41 in the d-axis direction. Thus, the contact force 43 can be substantially zero. Therefore, it is possible to control the contact force 43 by determining the driving force 41 in the d-axis direction using equation (7). That is, the state of contact between the stator 2 and the mover 3a can be controlled.

By using both the above-described driving force 41 in the d-axis direction and the driving force 40 in the transport direction as the driving force information, current control can be performed in the same manner as in equations (1) to (6). As described above, desired driving force 40 in the transport direction and driving force 41 in the d-axis direction can be applied to the mover 3 on the linear module 21.

As the attractive force information, the design value derived from the gap between the coil 201 in the linear module 21 and the permanent magnet 31 may be retained, or a value measured using a force gauge or the like during start-up adjustment may be retained.

While the example in which Gain=1 and, thus, the contact force 43 is set to zero has been described above, setting is not limited thereto. It is desirable to perform the setting so that a change in the contact force 43 between neighboring modules is minimized.

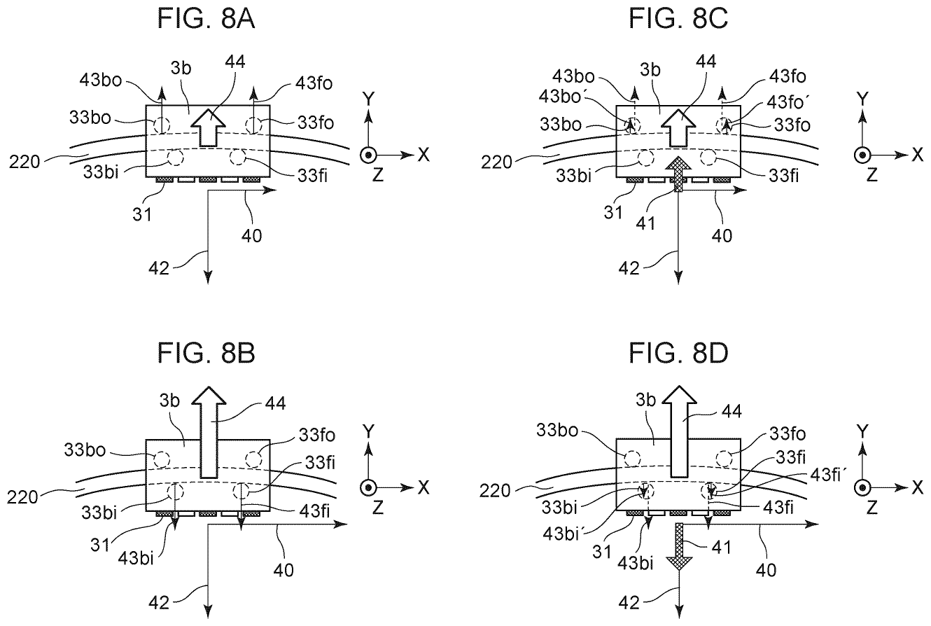

A control method performed on the curved module 22 is described below with reference to FIGS. 8A to 8D.

In FIGS. 8A to 8D, the first direction, which is the transport direction, is the X-direction, and the second direction, which is perpendicular to the first direction, is the Y-direction. The first direction is also the tangential direction of the curved module 22, and the second direction corresponds to the radial direction of the curved module 22.

FIGS. 8A and 8B illustrate forces acting on the mover 3b in an existing system. As in the above-described control on the linear module 21, the mover 3b is subjected to the attractive force 42, the driving force 40 in the transport direction (the first direction), and the contact force 43 acting between the curved section guide 220 and the sliding part 33. In addition, the mover 3b is subjected to a centrifugal force 44, depending on the driving state of the mover 3b.

FIG. 8A illustrates the forces acting on the mover 3b during low-velocity drive, and FIG. 8B illustrates the forces acting on the mover 3b during high-velocity drive. The action of the centrifugal force 44 changes the state of contact between the mover 3b and the curved section guide 220 and, thus, the direction of the contact force 43 and the contact points in FIG. 8B differ from those in FIG. 8A.

FIGS. 8C and 8D illustrate the forces acting on the mover 3b according to the first embodiment. In addition to the forces illustrated in FIGS. 8A and 8B, a driving force 41 in the d-axis direction (the second direction) is applied to the mover 3b. The applied driving force 41 in the d-axis direction can act to reduce the contact force 43. In FIG. 8C, contact forces 43bo and 43fo (denoted by dashed lines) are reduced to contact forces 43bo′ and 43fo′ (denoted by solid lines,), respectively, by the driving force 41 in the d-axis direction. In FIG. 8D, contact forces 43bi and 43fi (denoted by dashed lines) are reduced to contact forces 43bi′ and 43fi′ (denoted by solid lines,), respectively, by the driving force 41 in the d-axis direction.

A method for determining the driving force 41 in the d-axis direction on the curved module 22 is described below.

As described above, as the forces in the second direction, the attractive force 42, the contact force 43, and the centrifugal force 44 act on the mover 3b. As in the case on the linear module 21 described above, for example, attractive force information is retained in, for example, the transport controller 12 or the motor controller 13, and Fmag denotes the magnitude of the attractive force 42, which is the attractive force information, and Fc denotes the magnitude of the centrifugal force 44. Then, the magnitude FdRef of the driving force 41 in the d-axis direction can be determined as follows:

$$FdRef = - Gain \times ( Fmag - Fc ) , \qquad ( 8 )$$

where Gain is the effective ratio of the driving force 41 in the d-axis direction to a resultant force of the attractive force 42 and the centrifugal force 44. For example, in a case where Gain=1, a force equal in magnitude to the resultant force of the attractive force 42 and the centrifugal force 44 and directed oppositely is applied to the mover 3 as the driving force 41 in the d-axis direction. Thus, the contact force 43 can be substantially zero. Therefore, it is possible to control the contact force 43 by determining the driving force 41 in the d-axis direction using equation (8). That is, the state of contact between the stator 2 and the mover 3b can be controlled.

The magnitude Fc of the centrifugal force 44 is a quantity that depends on a velocity Vel, a rate of acceleration or deceleration Acc, and/or a position X of the mover 3b, and a curvature C(X) at the position of the mover 3b in the curved module 22.

For simplicity, the case is discussed below where the mover 3b is driven at a constant velocity on the curved module 22. Then, by additionally using a mass m of the mover 3b, the centrifugal force Fc is expressed as follows:

$$Fc = - m \times ( Vel \hat{} 2 ) \times C ( X ) . \qquad ( 9 )$$

The curvature is retained in the transport controller 12 or the motor controller 13 as curved module information. The curvature may be the design value of the curved section guide 220 or a value measured during start-up adjustment, or the like. As described above, the driving force 41 in the d-axis direction can be determined using equations (8) and (9).

Both the above-described driving force 41 in the d-axis direction and driving force 40 in the transport direction are used as driving force information, and current control can be performed using the above-described equations (1) to (6). As described above, desired driving force 40 in the transport direction and driving force 41 in the d-axis direction can be applied to the mover 3b on the curved module 22.

While, as in the above-described control on the linear module 21, the example in which Gain=1 and, thus, the contact force 43 is set to zero has been described above, setting is not limited thereto. It is desirable to perform the setting so that a change in the contact force 43 between neighboring modules is minimized.

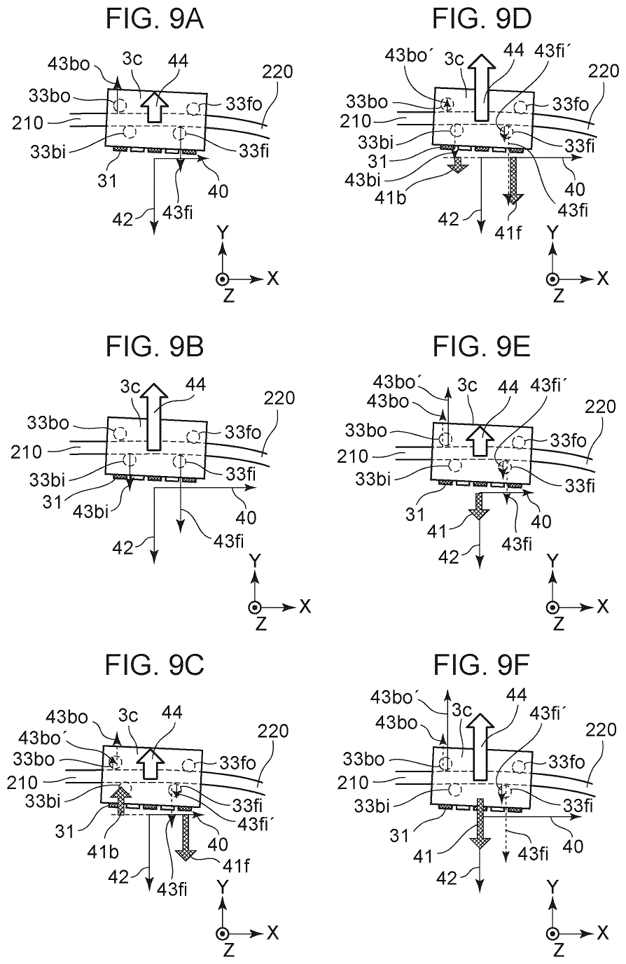

A control method performed on a boundary between the linear module 21 and the curved module 22 is described below with reference to FIGS. 9A to 9F. In FIGS. 9A to 9F, as described above, the first direction, which is the transport direction, is the X-direction, and the second direction, which is perpendicular to the first direction, is the Y-direction.

FIGS. 9A and 9B illustrate forces acting on the mover 3c in an existing system. As in the control method performed on the curved module 22 described above, the mover 3c is subjected to the attractive force 42, the driving force 40 in the transport direction, the contact force 43, and the centrifugal force 44. FIGS. 9A and 9B illustrate examples at low and high velocity drives, respectively.

FIGS. 9C to 9F illustrate forces acting on the mover 3c according to the first embodiment. In addition to the forces illustrated in FIGS. 9A and 9B, a driving force 41 in the d-axis direction (the second direction) is applied to the mover 3c. The applied driving force 41 in the d-axis direction can act to reduce the contact force 43. FIGS. 9C and 9D and FIGS. 9E and 9F illustrate two examples of different methods for applying the driving force 41 in the d-axis direction.

A method for determining the driving force 41 in the d-axis direction at the boundary between the linear module 21 and the curved module 22 is described below.

As described above, the attractive force 42, the contact force 43, and the centrifugal force 44 act on the mover 3c. As for the above-described curved module 22, for example, the attractive force information and the curved module information are retained in the transport controller 12 or the motor controller 13. By using the magnitude Fmag of the attractive force 42 in the attractive force information, the magnitude Fc of the centrifugal force 44 derived from the curved module information, and the drive profile of the mover 3c, the magnitude FdRef of the driving force 41 in the d-axis direction can be determined as in equations (8) and (9).

By determining the driving force 41 in the d-axis direction as described above, it is possible to control the contact force 43 applied to the mover 3c, as illustrated in FIGS. 9E and 9F. That is, the state of contact between the stator 2 and the mover 3c can be controlled. In FIGS. 9E and 9F, the contact forces 43bo and 43fi (denoted by dashed lines) are changed into the contact forces 43bo′ and 43fi′ (denoted by solid lines), respectively, by the driving force 41 in the d-axis direction.

Furthermore, for example, the case is discussed below where the driving force 41 in the d-axis direction is determined as described above and then, the front and rear portions of the mover 3c in the first direction are inclined to determine a current command value. Let FdRef_f be a component of the driving force 41 in the d-axis direction applied to half of the mover 3c on the positive side in the first direction (the front portion of the mover 3c), and FdRef_b be a component of the driving force 41 in the d-axis direction applied to half of the mover 3c on the negative side in the first direction (the rear portion of the mover 3c).

Then, for example, FdRef_f and FdRef_b can be expressed as follows:

$$FdRef\_f = Ratio \times FdRef , and \qquad ( 10 )$$

$$FdRef\_b = ( 1 - Ratio ) \times FdRef , \qquad ( 11 )$$

where Ratio is the distribution ratio of the driving force 41 in the d-axis direction. However, Ratio is not limited to a value between 0 and 1. For example, in a case where a value greater than 1 is set, the driving force 41 in the d-axis direction can be distributed as illustrated in FIG. 9C. In a case where a value between 0 to 1 (inclusive) is set, the driving force 41 in the d-axis direction can be distributed as illustrated in FIG. 9D.

As illustrated in FIGS. 9A and 9B, the state of contact varies because the magnitude of the centrifugal force 44 acting on the mover 3c varies with the drive profile of the mover 3c. Therefore, for example, a function Ratio(X,Vel,Acc) based on the drive profile may be set so that Ratio≥1 at low velocity drive and 0<Ratio<1 at high velocity drive.

By using equations (10) and (11), the magnitude of the driving force 41 in the d-axis direction is determined. At this time, for example, if, in the above-described positional relationship illustrated in FIG. 13, the component FdRef_b is applied using the current outputs to the coils 201(1) to 201(3) and the component FdRef_f is applied using the current outputs to the coils 201(4) to 201(6), the following equations can be obtained:

$$Fdm\_f = Fd ( 1 , X ) \times i ( 1 ) + F d ( 2 , X ) \times i ( 2 ) + F d ( 3 , X ) \times i ( 3 ) , and \qquad ( 12 )$$

$$Fdm\_b = Fd ( 4 , X ) \times i ( 4 ) + F d ( 5 , X ) \times i ( 5 ) + F d ( 6 , X ) \times i ( 6 ) . \qquad ( 13 )$$

Therefore, the current command value of each of the coils 201 can be uniquely obtained in the above-described manner. Thus, it is possible to control the contact force 43 applied to the mover 3c, as illustrated in FIGS. 9C and 9D. In FIG. 9C, the contact forces 43bo and 43fi (denoted by dashed lines) are changed into the contact forces 43bo′ and 43fi′ (denoted by solid lines) by the driving force 41 in the d-axis direction. In FIG. 9D, the contact forces 43bi and 43fi (denoted by dashed lines) are changed into the contact forces 43bo′ and 43fi′ (denoted by solid lines) by the driving force 41 in the d-axis direction.

Through the method described above, the state of contact between the stator 2 and the mover 3c can be controlled by applying the driving force 41 in the d-axis direction to the mover 3c based on the attractive force 42, the curvature of the curved module 22, and the drive profile of the mover 3c. That is, the driving force 41 in the d-axis direction is determined based on the external force applied to the mover 3c. The external force includes the centrifugal force 44 generated when the mover 3c is driven, in addition to the attractive force 42 described above.

The control of the mover 3 in the transport system 1 has been described above. Unlike existing systems, according to the first embodiment, a change in the contact force 43 can be reduced by the action of the driving force 41 in the d-axis direction. That is, vibration and abnormal noise caused by a change in the state of contact between the stator 2 and the sliding part 33 can be reduced.

Therefore, the mover 3 can be driven at high velocity on the curved module 22 without reducing the transport velocity.

### Second Embodiment

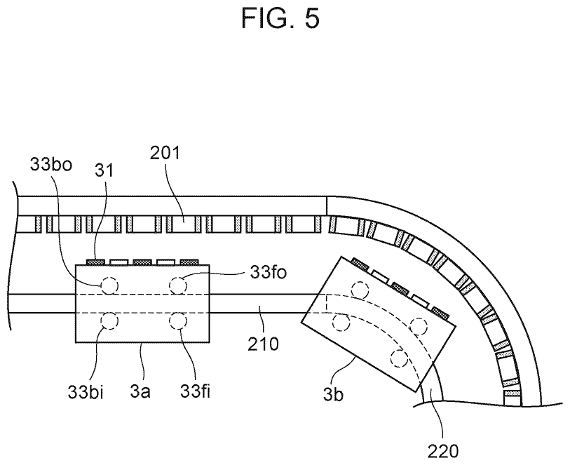

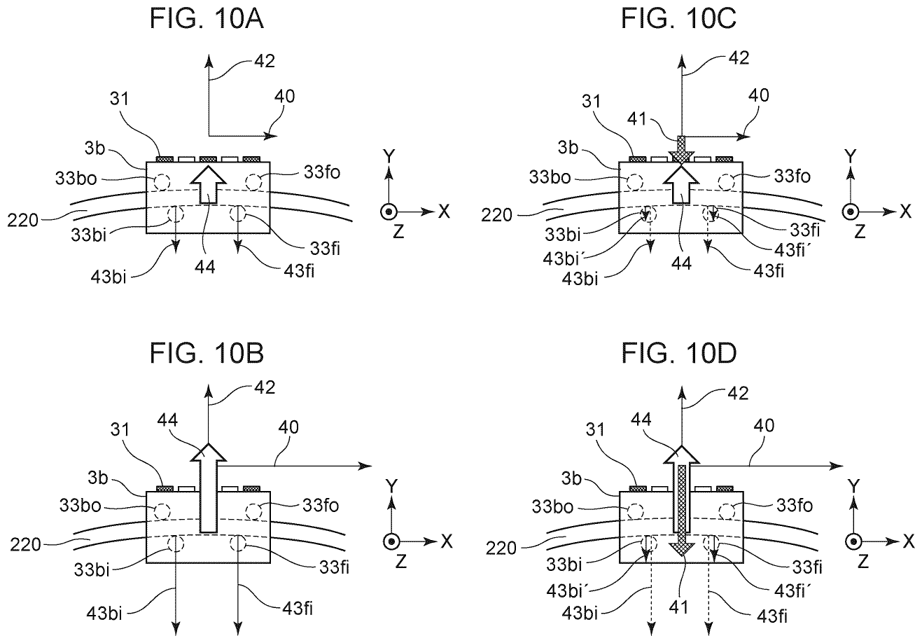

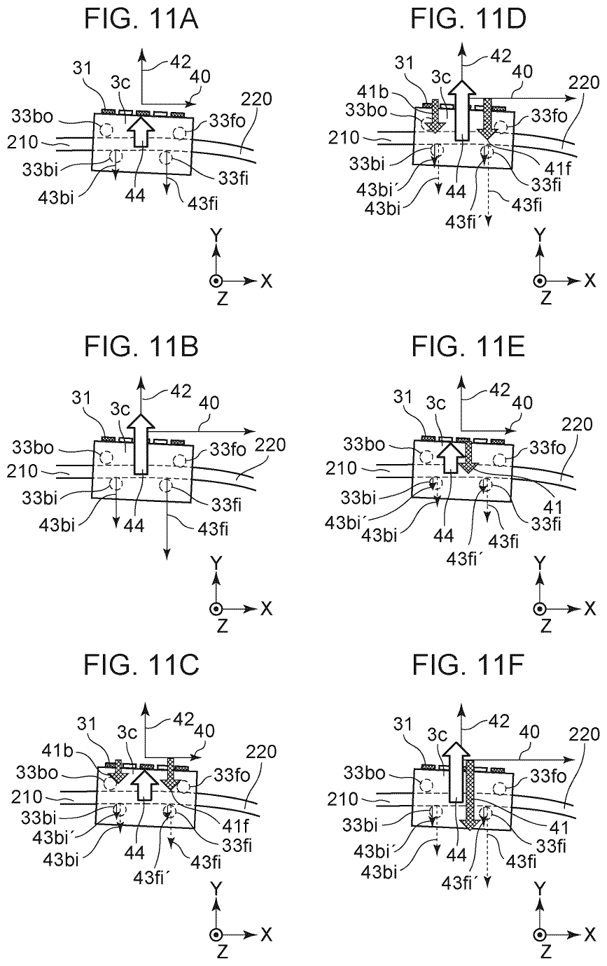

A driving method according to the second embodiment is described below with reference to FIG. 5, FIGS. 10A to 10D, and FIGS. 11A to 11F.

FIG. 5 illustrates the arrangement of coils and permanent magnets according to the second embodiment. Movers 3a and 3b are disposed on a linear section guide 210 and a curved section guide 220, respectively, on a stator 2 (not illustrated), and the curved section has a so-called inner rotor configuration in which the coil 201 is disposed on an outer side in the radial direction. The mover 3 has, disposed therein, a front outside roller 33fo, a front inside roller 33fi, a rear outside roller 33bo, and a rear inside roller 33bi, which serve as a sliding part 33 on a guide.

A control method performed on a curved module 22 having an inner rotor configuration is described below with reference to FIGS. 10A to 10D. In FIGS. 10A to 10D, a first direction, which is the transport direction, is the X-direction, and a second direction, which is perpendicular to the first direction, is the Y-direction. The first direction is the tangential direction of the curved module 22, and the second direction corresponds to the radial direction of the curved module 22.

FIGS. 10A and 10B illustrate forces acting on the mover 3b in an existing system. Like the above-described control performed on the linear module 21, the mover 3b is subjected to the attractive force 42, the driving force 40 in the transport direction acting in the first direction, and the contact force 43 acting between the curved section guide 220 and the sliding part 33, as well as the centrifugal force 44 in accordance with the driving state of the mover 3b. FIG. 10A illustrates the forces acting on the mover 3b at low velocity drive, and FIG. 10B illustrates the forces acting on the mover 3b at high velocity drive.

The action of the centrifugal force 44 changes the state of contact between the mover 3b and the curved section guide 220.

FIGS. 10C and 10D illustrate the forces acting on the mover 3b according to the second embodiment. In addition to the forces illustrated in FIGS. 10A and 10B, a driving force 41 in the d-axis direction (the second direction) is applied to the mover 3b. The driving force 41 applied in the d-axis direction can act to reduce the contact force 43. In FIGS. 10C and 10D, the contact forces 43bi and 43fi (denoted by dashed lines) are changed into contact forces 43bi′ and 43fi′ (denoted by solid lines), respectively, by the driving force 41 in the d-axis direction.

As compared with the control performed on the curved module 22 according to the first embodiment, the direction of the attractive force 42 that acts on the mover 3b differs in the second embodiment. Therefore, the magnitude of the driving force 41 in the d-axis direction can be determined by the same calculation as in equations (8) and (9).

Therefore, the state of contact between the stator 2 and the mover 3b can be controlled by applying the driving force 41 in the d-axis direction to the mover 3b based on the attractive force, the curvature of the curved module 22, and the drive profile of the mover 3b.

A control method performed at the boundary between the linear module 21 and the curved module 22 having an inner rotor configuration is described below with reference to FIGS. 11A to 11F. In FIGS. 11A to 11F, as described above, a first direction (the transport direction) is the X-direction, and a second direction, which is perpendicular to the first direction, is the Y-direction.

FIGS. 11A and 11B illustrate forces acting on the mover 3c in an existing system.

As in the above-described control method performed on the curved module 22, the mover 3c is subjected to the attractive force 42, the driving force 40 in the transport direction, the contact force 43, and the centrifugal force 44. FIG. 11A illustrates the forces at low velocity drive, and FIG. 11B illustrates the forces at high velocity drive.

FIGS. 11C to 11F illustrate forces acting on the mover 3c according to the second embodiment. In addition to the forces illustrated in FIGS. 11A and 111B, a driving force 41 in the d-axis direction (the second direction) is applied to the mover 3c. The applied driving force 41 in the d-axis direction can act to reduce the contact force 43. FIGS. 11C and 11D and FIGS. 11E and 11F illustrate two examples of different methods for applying the driving force 41 in the d-axis direction.

As compared with the control performed on the boundary between the linear module 21 and the curved module 22 according to the first embodiment, the direction of the attractive force 42 that acts on the mover 3c differs in the second embodiment. Therefore, the magnitude of the driving force 41 in the d-axis direction can be determined by the same calculation as in equations (8) to (13).

In FIGS. 11C to 11F, the contact forces 43bi and 43fi (denoted by dashed lines) are changed into contact forces 43bi′ and 43fi′ (denoted by solid lines), respectively, by the driving force 41 in the d-axis direction.

Therefore, the state of contact between the stator 2 and the mover 3c can be controlled by applying the driving force 41 in the d-axis direction to the mover 3c based on the attractive force, the curvature of the curved module 22, and the drive profile of the mover 3c.

The control of the mover 3 in the transport system 1 has been described above. According to the second embodiment, unlike existing systems, a change in the contact force 43 can be reduced by the action of the driving force 41 in the d-axis direction. That is, vibration and abnormal noise caused by a change in the state of contact between the stator 2 and the sliding part 33 can be reduced.

Therefore, the mover 3 can be driven on the curved module 22 at high velocity without reducing the transport velocity.

Although the first and second embodiments have been described above separately, the configurations according to the first and second embodiments can be mixed depending on the configuration of the curved module 22 of the transport system 1. That is, a module in which the permanent magnet 31 is disposed on the outer side in the radial direction with respect to the coil 201 in a curved section and a module in which the permanent magnet 31 is disposed on the inner side in the radial direction in a curved section may be mixed. Even in this case, by applying the driving force in the d-axis direction in the above-described manner, a change in the contact force 43 can be reduced, and the mover 3 can be driven at high velocity even in the curved section.

### Third Embodiment

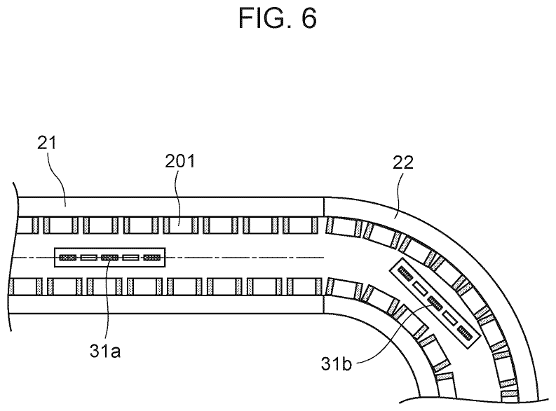

A driving method according to the third embodiment is described below. FIG. 6 illustrates the arrangement of coils 201 and permanent magnets 31 according to the third embodiment. The configuration is such that permanent magnets 31a and 31b, which are disposed on the mover 3a and the mover 3b, respectively, are sandwiched between coils 201, which are disposed on the stator 2. Thus, the configuration is designed such that an attractive force 42 acting on the mover 3 is substantially zero.

Therefore, the influence of the attractive force 42 described above in the first and second embodiments is negligible. For this reason, the state of contact between the stator 2 and the sliding part 33 is easily changed by the drive profile, which is information regarding the velocity, the rate of acceleration or deceleration, and the position of the mover 3.

Like the first and second embodiments described above, according to the present embodiment, a change in the contact force 43 can be reduced by applying a driving force 41 in the d-axis direction to the mover 3 and, thus, the mover 3 can be driven at high velocity even in a curved section.

According to the present embodiment, since the influence of the attractive force 42 is negligible, the effect of the driving force 41 in the d-axis direction is greater than in the first and second embodiments.

### Fourth Embodiment

A driving method according to the fourth embodiment is described below. According to the fourth embodiment, an example of a vertical transport system is configured. In the present system, some of the linear and/or curved sections extend in a vertical plane and, therefore, the gravitational force acts on the mover 3 as forces in the first and second directions.

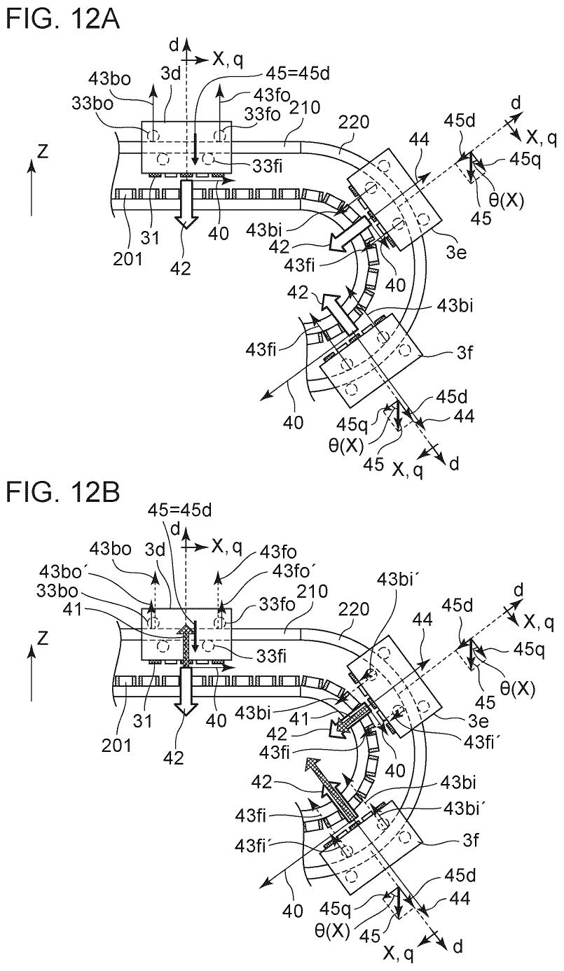

FIGS. 12A and 12B illustrate the arrangement of the coils 201 and permanent magnets 31 and forces acting on a mover 3 according to a vertical transport system configuration. In FIGS. 12A and 12B, a first direction is a q-axis direction serving as the transport direction, and a second direction, which is perpendicular to the first direction, is a d-axis direction. The first direction is the tangential direction of a curved module 22, and the second direction corresponds to the radial direction of the curved module 22.

FIG. 12A illustrates forces acting on movers 3d to 3f in an existing system. The mover 3d is controlled on a linear module 21, while the movers 3e and 3f are controlled on a curved module 22. The mover 3e is an example of a mover driven at low velocity, and the mover 3f is an example of a mover driven at high velocity.

The mover 3d is subjected to an attractive force 42, a driving force 40 in the transport direction, a contact force 43 between a linear section guide 210 and a sliding part 33, and a gravitational force 45.

In addition to the forces acting on the mover 3d, a centrifugal force 44 acts on each of the movers 3e and 3f. A force component 45q is a gravitational component in a q-axis direction (the first direction), and a force component 45d is a gravitational component in a d-axis direction (the second direction).

FIG. 12B illustrates forces acting on the movers 3d to 3f according to the fourth embodiment. A mover 3d is a mover controlled on the linear module 21, while movers 3e and 3f are movers controlled on the curved module 22. The mover 3e is an example of a mover driven at low velocity, and the mover 3f is an example of a mover driven at high velocity.

In addition to the forces acting on the mover 3d in the above-described existing system, a driving force 41 in the d-axis direction is applied to the mover 3d. Similarly, the driving force 41 in the d-axis direction is applied to each of the movers 3e and 3f in addition to the forces acting on the movers 3e and 3f in the above-described existing system.

A method for determining the driving force 41 in the d-axis direction on the linear module 21 will now be described.

As described above, the attractive force 42, the contact force 43, and the gravitational force 45 act on the mover 3d as the forces in the second direction. In FIG. 12B, because the linear module 21 is disposed so that the first direction is the horizontal direction, a component Fmg_q in the transport direction and a component Fmg_d in the d-axis direction of the gravitational force 45 are expressed using a magnitude Fmg of the gravitational force 45 as follows:

$$Fmg\_q = 0 , and \qquad ( 14 )$$

$$Fmg\_d = Fmg . \qquad ( 15 )$$

Therefore, a magnitude FdRef of the driving force 41 in the d-axis direction can be determined using equations (14) and (15) and the magnitude Fmag of the attractive force 42 as follows:

$$FdRef = - Gain \times ( - Fmag - Fmg\_d ) = - Gain \times ( - Fmag - Fmg ) , \qquad ( 16 )$$

where, Gain denotes the effective ratio of the driving force 41 in the d-axis direction to the resultant force of the attractive force 42 and the component of the gravitational force 45 in the d-axis direction. For example, in a case where Gain=1, a force equal in magnitude to the resultant force of the attractive force 42 and the component of the gravitational force 45 in the d-axis direction and directed oppositely is applied to the mover 3d as the driving force in the d-axis direction. Thus, the contact force 43 can be substantially zero. Therefore, it is possible to control the contact force 43 by determining the driving force 41 in the d-axis direction using equation (16). That is, the state of contact between the stator 2 and the mover 3d can be controlled.

In FIG. 12B, the contact forces 43bo and 43fo (denoted by dashed lines) that act on the mover 3d are changed into contact forces 43bo′ and 43fo′ (denoted by solid lines), respectively, by the driving force 41 in the d-axis direction.

While the example in which the direction in which the gravitational force 45 is applied to the mover 3d is the negative d-axis direction has been described, the direction in which the gravitational force 45 is applied may be the positive d-axis direction depending on the position of the curved module 22, for example, in a case where the control is performed on the linear module 21 (not illustrated) serving as a destination of the mover 3f on the lower side in the Z-axis direction. That is, equation (15) is changed to

$$Fmg\_d = - Fmg .$$

Even in this case, the driving force 41 in the d-axis direction can be determined, and the state of contact of the mover 3 can be controlled in the same manner as described above.

While the configuration in which the linear module 21 is extended in the horizontal direction has been discussed, the configuration is not limited thereto. Even in a configuration in which the linear module 21 is extended in the vertical direction or is inclined, the magnitude of the driving force 41 in the d-axis direction can be determined in the same way by decomposing the gravitational force 45 into the components in the q-axis and d-axis directions.

By using both the above-described driving force 41 in the d-axis direction and the driving force 40 in the transport direction as driving force information, current control can be performed by the same calculation as in the above-described equations (1) to (6). As described above, even in the fourth embodiment, desired driving force 40 in the transport direction and driving force 41 in the d-axis direction can be applied to the mover 3 on the linear module 21.

A method for determining the driving force 41 in the d-axis direction on the curved module 22 is described below.

As described above, the movers 3e and 3f are subjected to the attractive force 42, the contact force 43, the centrifugal force 44, and a component of the gravitational force 45 in the d-axis direction as the forces in the d-axis direction. In FIG. 12B, a component Fmg_q of the gravitational force 45 in the transport direction and a component Fmg_d of the gravitational force 45 in the d-axis direction can be expressed using the position X of the mover 3e or 3f on the curved module and the magnitude Fmg of the gravitational force 45 as follows:

$$Fmg\_q = Fmg \times cos ( θ ( X ) ) , and \qquad ( 17 )$$

$$Fmg\_d = Fmg \times sin ( θ ( X ) ) , \qquad ( 18 )$$

where θ(X) is the angle of the mover 3 determined in accordance with the position X on the curved module 22 of the mover 3e or 3f. θ(X) is retained in the transport controller 12 or the motor controller 13 as the curved module information.

Therefore, the magnitude FdRef of the driving force 41 in the d-axis direction can be determined using equations (17) and (18), the magnitude Fmag of the attractive force 42, and the magnitude Fc of the centrifugal force 44 as follows:

$$FdRef = - Gain \times ( - Fmag - Fmd\_d + Fc ) , \qquad ( 19 )$$

where Gain is the effective ratio of the driving force 41 in the d-axis direction to the resultant force of the attractive force 42, the centrifugal force 44, and the component of the gravitational force 45 in the d-axis direction. For example, in a case where Gain=1, a force equal in magnitude to the resultant force of the attractive force 42, the centrifugal force 44, and the component of the gravitational force 45 in the d-axis direction and directed oppositely is applied to the mover 3 as the driving force 41 in the d-axis direction. Thus, the contact force 43 can be substantially zero.

The magnitude Fc of the centrifugal force 44 is a quantity that depends on the velocity Vel, rate of acceleration or deceleration Acc, and/or position X of the mover 3e or 3f and the curvature C(X) of the curved module 22 at the position of the mover 3e or 3f.

For simplicity, the case where the movers 3e and 3f are driven at constant velocity on the curved module 22 is discussed. Then, by additionally using a mass m of the mover 3e or 3f, the centrifugal force Fc is expressed as follows:

$$Fc = - m \times ( Vel \hat{} 2 ) \times C ( X ) . \qquad ( 20 )$$

Therefore, the contact force 43 can be controlled by determining the driving force 41 in the d-axis direction using equations (17) to (20). That is, the state of contact between the stator 2 and each of the movers 3e and 3f can be controlled.

In FIG. 12B, the contact forces 43bi and 43fi (denoted by dashed lines) acting on each of the movers 3e and 3f are changed into the contact forces 43bi′ and 43fi′ (denoted by solid lines) by the driving force 41 in the d-axis direction.

The control of the mover 3 according to the fourth embodiment has been described above. Unlike existing systems, according to the fourth embodiment, a change in the contact force 43 can be reduced by the action of the driving force 41 in the d-axis direction. That is, vibration and abnormal noise caused by a change in the state of contact between the stator 2 and the sliding part 33 can be reduced.

Therefore, the mover 3 can be driven at high velocity on the curved module 22 without reducing the transport velocity.

As described above, in a moving magnet linear motor system with linear and curved sections, the state of contact between the stator 2 and the mover 3 can be controlled by applying the driving force 41 in the d-axis direction to the mover 3 as a force in a second direction perpendicular to a first direction, which is the transport direction. That is, in the entire transport system, vibration and abnormal noise caused by a change in the state of contact between the stator 2 and the mover 3 can be reduced.

As a result, according to the present embodiment, the mover can be driven at high velocity on even the curved module 22 without reducing the transport velocity. In addition, because position information in the second direction is not used, there is no need for an additional sensor.

### Other Embodiments

In manufacturing systems for manufacturing products, such as electronic equipment, the transport system 1 according to the present disclosure can be used as a transport system for transporting the workpiece 4 that constitutes the product and that is loaded on the mover 3 to the work area of each of process apparatuses, such as machine tools, which perform the work processes on the workpiece 4. The process apparatus that performs the work process may be an apparatus that performs any type of processing (for example, an apparatus that performs assembly of parts to the workpiece or an apparatus that performs painting). The product to be manufactured is not limited to a specific product but may be any part.

As described above, a workpiece can be transported to the work area by using the transport system according to the present disclosure, and a work process can be performed on the workpiece transported to the work area to manufacture a product.

The effects described in each of the embodiments are only exemplary effects arising from the technology of the present disclosure, and the effects of the disclosed technology are not limited to those described above.

The disclosure of the present embodiments includes the configurations described below.

### (Configuration 1)

A transport apparatus includes a stator including a curved section and a control unit configured to control a position and a velocity of a mover that moves in a first direction while in contact with the stator. The control unit applies a driving force to the mover in a second direction that is perpendicular to the first direction when the mover moves on the curved section.

### (Configuration 2)

In the transport apparatus described in Configuration 1, the control unit determines the magnitude of the driving force in the second direction based on the magnitude of an external force acting on the mover in the second direction.

### (Configuration 3)

In the transport apparatus described in Configuration 2, the external force is the centrifugal force acting on the mover.

### (Configuration 4)

In the transport apparatus described in Configuration 3, the control unit derives the magnitude of the centrifugal force based on a drive profile of the mover.

### (Configuration 5)

In the transport apparatus described in Configuration 2, the stator includes a coil, and the external force is an attractive force acting between the coil and a permanent magnet included in the mover.

### (Configuration 6)

In the transport apparatus described in Configuration 1, the control unit applies the driving force in the second direction such that the driving force is distributed between a front portion and a rear portion of the mover in the first direction.

### (Configuration 7)

In the transport apparatus described in Configuration 6, to distribute the driving force, the control unit determines a distribution ratio between the front portion and the rear portion based on a drive profile of the mover.

### (Configuration 8)

In the transport apparatus described in Configuration 2, at least part of the stator is extended in a vertical plane, and the external force is a component of a gravitational force acting on the mover in the second direction.

### (Configuration 9)

In the transport apparatus described in any one of Configurations 1 to 8, the stator includes a linear section and a curved section, and the control unit determines the magnitude of the driving force in the second direction at a boundary between the linear section and the curved section that neighbor each other so that a change in a contact force of the mover is minimized as the mover crosses the boundary.

### (Configuration 10)

A control method for controlling a transport apparatus is provided. The transport apparatus includes a stator including a curved section, and a control unit configured to control a position and a velocity of a mover that moves in a first direction while in contact with the stator. The method includes applying a driving force to the mover in a second direction that is perpendicular to the first direction when the mover moves on the curved section.

### (Configuration 11)

In the control method described in Configuration 10, in applying a driving force, the magnitude of the driving force in the second direction is determined based on the magnitude of an external force acting on the mover in the second direction.

### (Configuration 12)

In the control method described in Configuration 11, the external force is a centrifugal force acting on the mover.

### (Configuration 13)

In the control method described in Configuration 12, the magnitude of the centrifugal force is derived based on a drive profile of the mover.

### (Configuration 14)

In the control method described in Configuration 11, the external force is an attractive force acting between a coil included in the stator and a permanent magnet included in the mover.

### (Configuration 15)

In the control method described in Configuration 10, in applying a driving force, the driving force is applied in the second direction such that the driving force is distributed between a front portion and a rear portion of the mover in the first direction.

### (Configuration 16)

In the control method described in Configuration 15, in distributing the driving force, a distribution ratio between the front portion and the rear portion is determined based on a drive profile of the mover.

### (Configuration 17)

In the control method described in Configuration 11, in a case where at least part of the stator is extended in a vertical plane, the external force is a component of a gravitational force acting on the mover in the second direction.

### (Configuration 18)

In the control method described in Configuration 10, in applying the driving force in a case where the stator includes a linear section and a curved section, the magnitude of the driving force in the second direction at a boundary between the linear section and the curved section that neighbor each other is determined so that a change in a contact force of the mover is minimized as the mover crosses the boundary.

### (Configuration 19)

A transport system includes a stator including a curved section, a mover configured to move in a first direction while in contact with the stator, and a control unit configured to control a position and a velocity of the mover. The control unit applies a driving force to the mover in a second direction that is perpendicular to the first direction when the mover moves on the curved section.

### (Configuration 20)

A method for manufacturing a product using the transport apparatus described in any one of Configurations 1 to 9 includes transporting a workpiece loaded on the mover and processing the workpiece with an apparatus for processing the product.

The present disclosure can provide a technology that, in moving magnet linear motor systems, enables high-velocity driving of a mover with reduced vibration of the mover in linear and curved sections without changing the transport velocity, while keeping apparatus costs low.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-203721, filed Nov. 22, 2024, the entirety of which is incorporated herein by reference.

What is claimed is:

1. A transport apparatus comprising:
a stator including a curved section; and
a control unit configured to control a position and a velocity of a mover that moves in a first direction while in contact with the stator,
wherein the control unit applies a driving force to the mover in a second direction that is perpendicular to the first direction when the mover moves on the curved section.

2. The transport apparatus according to claim 1, wherein the control unit determines a magnitude of the driving force in the second direction based on a magnitude of an external force acting on the mover in the second direction.

3. The transport apparatus according to claim 2, wherein the external force is a centrifugal force acting on the mover.

4. The transport apparatus according to claim 3, wherein the control unit derives a magnitude of the centrifugal force based on a drive profile of the mover.

5. The transport apparatus according to claim 2, wherein the stator includes a coil, and
wherein the external force is an attractive force acting between the coil and a permanent magnet included in the mover.

6. The transport apparatus according to claim 1, wherein the control unit applies the driving force in the second direction such that the driving force is distributed between a front portion and a rear portion of the mover in the first direction.

7. The transport apparatus according to claim 6, wherein to distribute the driving force, the control unit determines a distribution ratio between the front portion and the rear portion based on a drive profile of the mover.

8. The transport apparatus according to claim 2, wherein at least part of the stator is extended in a vertical plane, and
wherein the external force is a component of a gravitational force acting on the mover in the second direction.

9. The transport apparatus according to claim 1, wherein the stator includes a linear section and the curved section, and
wherein the control unit determines a magnitude of the driving force in the second direction at a boundary between the linear section and the curved section that neighbor each other so that a change in a contact force of the mover is minimized as the mover crosses the boundary.

10. A control method for controlling a transport apparatus, the transport apparatus including: a stator including a curved section; and a control unit configured to control a position and a velocity of a mover that moves in a first direction while in contact with the stator, the method comprising:
applying a driving force to the mover in a second direction that is perpendicular to the first direction when the mover moves on the curved section.

11. The method according to claim 10, wherein, in applying the driving force, a magnitude of the driving force in the second direction is determined based on a magnitude of an external force acting on the mover in the second direction.

12. The method according to claim 11, wherein the external force is a centrifugal force acting on the mover.

13. The method according to claim 12, wherein a magnitude of the centrifugal force is derived based on a drive profile of the mover.

14. The method according to claim 11, wherein the external force is an attractive force acting between a coil included in the stator and a permanent magnet included in the mover.

15. The method according to claim 10, wherein, in applying the driving force, the driving force is applied in the second direction such that the driving force is distributed between a front portion and a rear portion of the mover in the first direction.

16. The method according to claim 15, wherein, in distributing the driving force, a distribution ratio between the front portion and the rear portion is determined based on a drive profile of the mover.

17. The method according to claim 11, wherein, in a case where at least part of the stator is extended in a vertical plane, the external force is a component of a gravitational force acting on the mover in the second direction.

18. The method according to claim 10, wherein, in applying the driving force in a case where the stator includes a linear section and the curved section, a magnitude of the driving force in the second direction at a boundary between the linear section and the curved section that neighbor each other is determined so that a change in a contact force of the mover is minimized as the mover crosses the boundary.

19. A transport system comprising:
a stator including a curved section;
a mover configured to move in a first direction while in contact with the stator; and
a control unit configured to control a position and a velocity of the mover,
wherein the control unit applies a driving force to the mover in a second direction that is perpendicular to the first direction when the mover moves on the curved section.

20. A method for manufacturing a product using the transport apparatus according to claim 1, comprising:
transporting a workpiece loaded on the mover; and
processing the workpiece with an apparatus for processing the product.
